(19) United States
(12) Patent Application Publication
(10) Pub. No.: US 2012/0027091 A1
(43) Pub. Date: Feb. 2, 2012

(54) Method and System for Encoding Video Frames Using a Plurality of Processors

(76) Inventor: Wei-Lien Hsu, Austin, TX (US)

(21) Appl. No.: 12/845,293

(22) Filed: Jul. 28, 2010

(51) Int. Cl. H04N 7/26; H04N 7/64

(52) U.S. Cl. 375/240.16; 375/E07.125; 375/E07.279

(57) ABSTRACT

Methods and system provide for the encoding of video frames using a plurality of processors. In one example, a first processor provides a location of a plurality of non-stationary pixels in a current frame by comparing pixel data in the current frame with corresponding pixel data in a previous frame for use by a second processor. The first processor also provides pixel data describing substantially only non-stationary pixels in the current frame, for use by the second processor. The second processor calculates motion vector data for the plurality of non-stationary pixels based on the non-stationary pixel location information and the pixel data describing substantially only non-stationary pixels. The first processor encodes the current frame using the motion vector data for the plurality of non-stationary pixels from the second processor.

### FIELD OF THE DISCLOSURE

The present disclosure relates to a method and system for encoding video frames.

### BACKGROUND OF THE DISCLOSURE

Conventional video encoding systems utilize a number of techniques for reducing the amount of information that must be transmitted across a communication channel using its available bandwidth. These techniques strive to reduce the amount of information being transmitted across a communication channel using its available bandwidth without producing an unacceptable degradation in the decoded and displayed video. In order to reduce the amount of information being transmitted across a communication channel using its available bandwidth without degrading the output video to an unacceptable level, these techniques make use of temporal redundancy between successive video frames.

One exemplary technique used for reducing the amount of information that must be transmitted across a communication channel using its available bandwidth is called block-matching. A conventional block-matching algorithm seeks to identify blocks of pixels in an incoming (i.e., current) video frame as corresponding to (i.e., matching) blocks of pixels in a previously stored reference video frame. It is to be appreciated that a block can be, for example, a pixel, a collection of pixels, a region of pixels (of fixed or variable size), or substantially any portion of a video frame. Algorithms used for performing block-matching include, for example, mean square error (MSE), mean absolute difference (MAD), and sum absolute difference (SAD), amongst others, as recognized by those having skill in the art. Identifying matching blocks between successive video frames allows for the application of an additional bandwidth-conserving technique known as motion estimation.

Motion estimation is a technique that compares blocks of pixels in the current video frame with corresponding blocks of pixels in a previously stored reference video frame to determine how far the blocks of pixels in the current frame have moved from their location in the reference video frame. Motion estimation involves the calculation of a set of motion vectors. Each motion vector in the set of motion vectors represents the displacement of a particular block of pixels in the current video frame from the corresponding block of pixels in the stored reference video frame. By transmitting motion vector data for a given block of pixels rather than transmitting complete pixel data for each pixel in the block of pixels, bandwidth may be conserved. This is due to the fact that the motion vector data is substantially smaller than the pixel data for a given block of pixels.

A related issue affecting bandwidth and encoding speed is the physical architecture of the encoding system. For example, in many conventional encoding systems, block-matching and motion estimation are performed on the same processor, such as a central processing unit (CPU). However, motion estimation is recognized as being the most compute-intensive operation performed in video encoding. For example, when performing video encoding in-line with the H.264/AVC (advanced video encoding) standard, motion estimation computations account for as high as 70% of the total encoding time. As such, it is often undesirable to perform all of the encoding compression techniques on a single processor, as doing so restricts the processor's ability to simultaneously perform other operations unrelated to video encoding. Accordingly, existing techniques have off-loaded certain encoding computations to other processors.

For example, some existing encoding systems perform motion estimation on a graphics processing unit (GPU), rather than on the CPU. By off-loading motion estimation to another processor, such as a GPU, the primary processor (e.g., CPU) is freed up to perform other operations. While this design frees up the primary processor, it nonetheless suffers from a number of drawbacks.

For example, partitioning the encoding computations between processors can create a data bottleneck along the communication channel (e.g., a data bus) between the first processor (e.g., CPU) and the second processor (e.g., GPU). This data bottleneck is created based on the fact that the second processor is unable to process the incoming data as fast as it comes in. Accordingly, data sent to the second processor for processing must sit in queue until the second processor is able to process it. This problem is exacerbated by the fact that existing encoding systems send pixel data for all blocks of pixels to the GPU. This technique for encoding video frames is rife with inefficiencies related to computing complexity and processing speed.

Other encoding methods seek to reduce the memory traffic between two processors by sending subsampled pixel data from the first processor to the second processor. For example, one encoding method, known as chroma subsampling, seeks to reduce the memory traffic between processors by implementing less resolution for chroma information (i.e., “subsampling” the chroma information) than for luma information. However, such techniques tend to reduce the accuracy of, for example, the motion estimation that is performed by the second processor. This is because there is less information for consideration (e.g., less chroma information) in determining motion estimation when encoded data is subsampled.

Accordingly, there exists a need for an improved method and system for encoding video frames that decreases the complexity of video encoding computations while simultaneously reducing the time it takes to perform the video encoding.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting a system for encoding and decoding video frames using a plurality of processors in accordance with one example set forth in the present disclosure.

FIG. 2 is a flowchart illustrating one example of a method for encoding video frames using a plurality of processors.

FIG. 3 is a block diagram generally depicting an encoder for encoding video frames in accordance with one example set forth in the present disclosure.

FIG. 4 is a flowchart illustrating another example of a method for encoding video frames using a plurality of processors.

### DETAILED DESCRIPTION OF THE PREFERRED EMBODIMENTS

The present disclosure provides methods and system for encoding video frames using a plurality of processors. In one example, a method for encoding video frames using a plurality of processors is disclosed. In this example, the method includes providing, by a first processor, a location of a plurality of non-stationary pixels in a current frame. The location of the plurality of non-stationary pixels in the current frame is provided by comparing pixel data in the current frame with corresponding pixel data in a previous frame for use by a second processor. The first processor also provides pixel data describing substantially only non-stationary pixels in the current frame for use by the second processor. The second processor calculates motion vector data for the plurality of non-stationary pixels based on the non-stationary pixel location information and the pixel data describing substantially only non-stationary pixels. The first processor encodes the current frame using the motion vector data for the plurality of non-stationary pixels provided from the second processor.

In one example of the above method, the first processor generates error detection data in response to determining that the motion vector data for the plurality of non-stationary pixels exceeds a predetermined value. In another example, the first processor indicates that a new reference frame is available for use in calculating the motion vector data in response to generated error detection data. In one example, the motion vector data is calculated by determining a translational shift of the plurality of non-stationary pixels between the reference frame and the current frame. In yet another example, the reference frame includes pixel data describing non-stationary pixels in the current frame and pixel data describing stationary pixels in the current frame. In another example, the previous frame is the reference frame. In yet another example, the pixel data describing substantially only non-stationary pixels in the current frame comprises pixel data describing only non-stationary pixels in the current frame.

The present disclosure also provides a system for encoding and decoding video frames using a plurality of processors. In one example, the system includes a video encoder having a plurality of processors. In this example, the encoder has a first processor operative to provide a location of a plurality of non-stationary pixels in a current frame by comparing pixel data in the current frame with corresponding pixel data in a previous frame for use by a second processor. The first processor is further operative to provide pixel data describing substantially only non-stationary pixels in the current frame, for use by the second processor. The second processor is operatively connected to the first processor and operative to calculate motion vector data for the plurality of non-stationary pixels based on the non-stationary pixel location information and the pixel data describing substantially only non-stationary pixels. The first processor is additionally operative to encode the current frame using the motion vector data for the plurality of non-stationary pixels from the second processor. In this example, the system also includes a decoder operatively connected to the first processor and operative to decode the encoded current frame to provide a decoded current frame.

In one example, the first processor includes an error detection module operative to generate error detection data in response to determining that the motion vector data for the plurality of non-stationary pixels exceeds a predetermined value. In another example, the first processor includes a frame generation module operative to indicate that a new reference frame is available for use in calculating the motion vector data in response to receiving error detection data. In yet another example, the second processor includes a motion estimation module operative to determine a translational shift of the plurality of non-stationary pixels between a reference frame and the current frame in order to calculate motion vector data. In another example, the first processor includes a non-stationary pixel detection module operative to determine the location of the plurality of non-stationary pixels in the current frame and provide both non-stationary pixel location information corresponding to the current frame for use by the second processor and pixel data describing substantially only non-stationary pixels in the current frame for use by the second processor.

Among other advantages, the disclosed methods and system provide for accelerated video encoding, including motion estimation. The acceleration is accomplished by partitioning the encoding processing between a plurality of processors and reducing the amount of pixel data being sent between the processors. To that end, the disclosed methods and system also improve upon the latency created by transferring encoding processing operations between processors. Other advantages will be recognized by those of ordinary skill in the art.

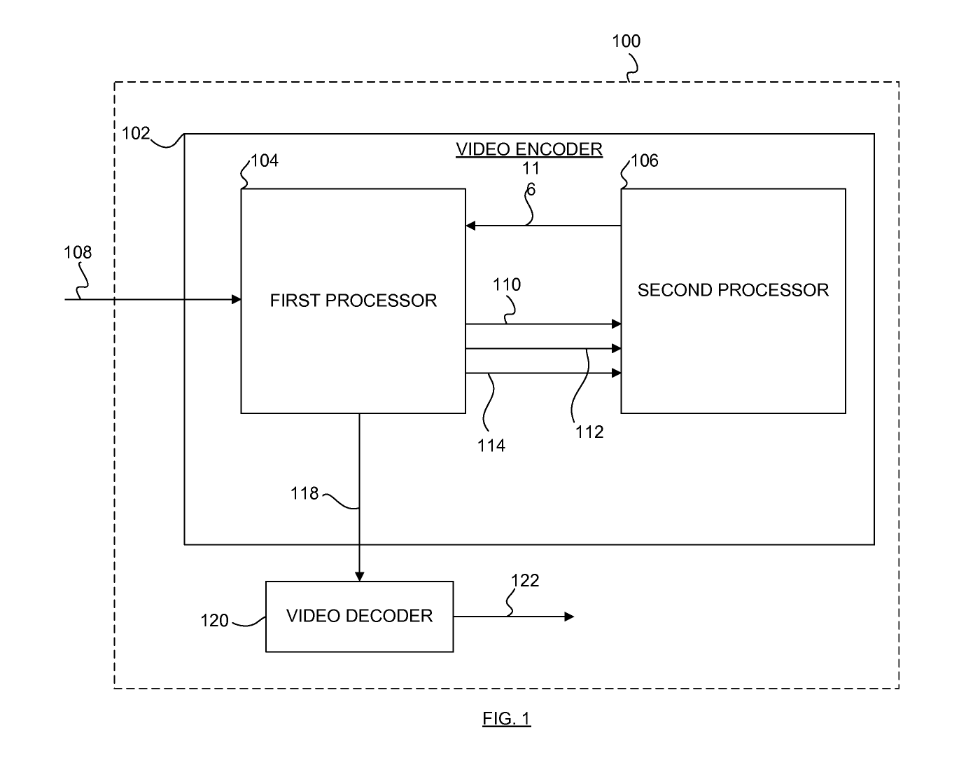

The following description of the embodiments is merely exemplary in nature and is in no way intended to limit the disclosure, its application, or uses. FIG. 1 illustrates one example of a system 100 for encoding and decoding video frames using a plurality of processors. The system 100 may exist in one or more electronic devices. For example, the video encoder 102 portion of the system 100 may exist in one electronic device while the video decoder 120 may exist in a different electronic device. Alternatively, the video encoder 102 and decoder 120 could exist in the same electronic device. The video encoder 102 and decoder 120 merely need to be operatively connected to one another, for example, through direct physical connection (e.g., a bus) or wireless connection via one or more communication networks (e.g., the Internet, cellular networks, etc.). For example, the video encoder/decoder 102, 120 may exist in electronic devices such as image capture devices (e.g., a camera or camcorder, either with or without recorded video playback via an integrated display device), personal computers (e.g., desktop or laptop computers), networked computing devices (e.g., server computers or the like, wherein each individual computing device implements one or more functions of the system 100), personal digital assistants (PDAs), cellular telephones, tablets (e.g., an Apple® iPad®), or any other suitable electronic device used for performing video encoding and/or decoding.

The system 100 includes a video encoder 102 for encoding an unencoded current (i.e., incoming) video frame 108. The unencoded video frame 108 is, for example, a raw (i.e., uncompressed) video frame containing pixel data describing each pixel in the frame. The pixel data may include, for example, one luma and two chrominance values for each pixel in the frame (e.g., YCbCr values, YUV values, YPbPr values, Y¹UV, etc.), as known in the art. Additionally, the pixel data may include coordinate values for each pixel in the frame such as, for example, x, y, and z coordinate values indicating each pixel's location in the frame. Also, as used herein, a frame may comprise any number of fields. For example, a single frame may comprise a “top field” describing odd-numbered horizontal lines in the frame image and a “bottom field” describing even-numbered horizontal lines in the frame image, as will be recognized by those having skill in the art.

The encoder 102 includes a first processor 104 operatively connected to a second processor 106. The processors 104, 106 may comprise microprocessors, microcontrollers, digital signal processors, or combinations thereof operating under the control of executable instructions stored in the storage components. In one example, the first processor 104 is a central processing unit (CPU). In one example, the second processor is a graphics processing unit (GPU). In another example, the second processor is a general purpose GPU (GPGPU). The first and second processors 104, 106 may exist as separate cores on a single die or separate cores on separate dies. Irrespective of the particular implementation, the disclosure is not limited to these specific examples and contemplates the use of any processors 104, 106 capable of performing the described functionality. The system 100 further includes a decoder 120 operatively connected to the first processor 104. As noted above, the decoder 120 and the first processor 104 may be operatively connected via any suitable physical or wireless connection.

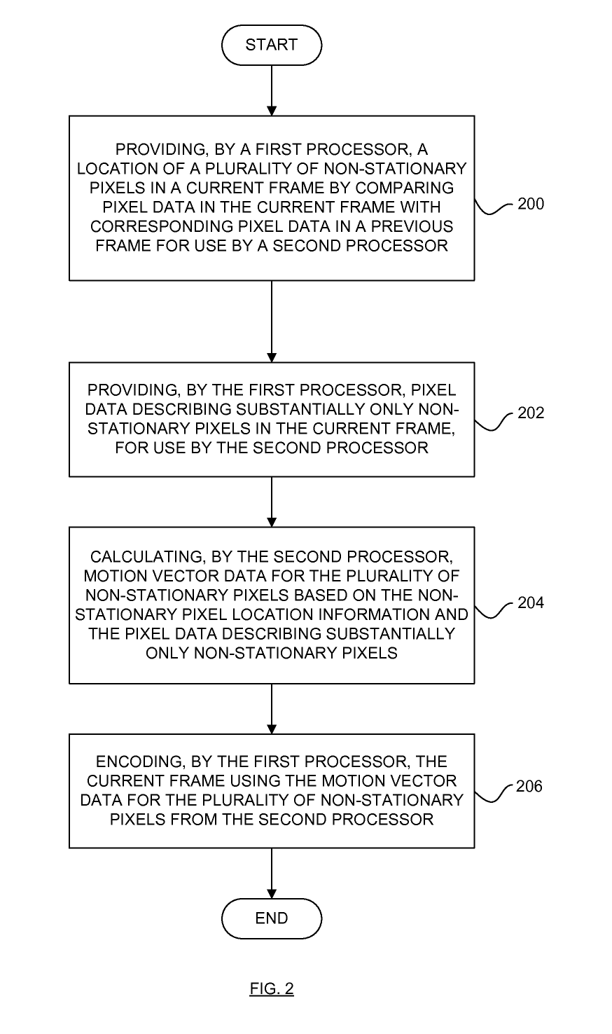

FIG. 2 is a flowchart illustrating one example of a method for encoding video frames using a plurality of processors. The method disclosed in FIG. 2 may be carried out by, for example, the system 100 depicted in FIG. 1. Accordingly, the method will be discussed with reference to the elements in the system 100. At step 200, a first processor 104 provides a location of a plurality of non-stationary pixels in a current frame 108 by comparing pixel data in the current frame 108 with corresponding pixel data in a previous frame for use by a second processor 106. In one example, the first processor 104 is operative to determine the location of the plurality of non-stationary pixels in the current frame 108 before providing the location information to the second processor 106. However, it is understood that this determination could be made equally well by other suitable logic.

Determining the location of a plurality of non-stationary pixels in a current video frame may be accomplished by, for example, a block-matching algorithm such as sum absolute difference (SAD). Block-matching algorithms, such as SAD, typically divide the current video frame 108 into macroblocks. Each macroblock may include any number of pixels. For example, a 16×16 macroblock may include 256 pixels (i.e., 16 pixels per row, for 16 rows). Each macroblock may be further divided into sub-blocks such as, for example, four 8×8 sub-blocks.

In order to determine the location of a plurality of non-stationary pixels in a current video frame 108, the block-matching algorithm compares pixel data in the current video frame 108 with corresponding pixel data in a previous video frame. This comparison may be accomplished on a plurality of pixels (e.g., macroblock) basis. That is to say, rather than comparing pixel data describing a single pixel in a current video frame 108 with pixel data describing a corresponding pixel in a previous video frame, the algorithm may compare a macroblock of pixels in the current video frame 108 with a corresponding macroblock of pixels in the previous video frame. Performing the comparison on a macroblock-to-macroblock basis rather than a pixel-to-pixel basis greatly reduces computational cost without a substantial effect on accuracy.

When comparing a macroblock from the current video frame 108 against a corresponding macroblock from the previous video frame, if the two macroblocks are determined to be the same, then the macroblock in the current video frame 108 is determined to be a stationary macroblock (i.e., a macroblock comprising a plurality of stationary pixels). If, however, the macroblock in the current video frame 108 is different than the corresponding macroblock in the previous video frame, then the macroblock in the current video frame 108 is determined to be a non-stationary macroblock (i.e., a macroblock comprising a plurality of non-stationary pixels).

The comparison is carried out by subtracting a value assigned to a macroblock in the current video frame 108 from a value assigned to a corresponding macroblock in the previous video frame. The values may represent, for example, the luma values of the pixels making up the macroblock in the current video frame 108 and the luma values of the pixels making up the macroblock in the previous video frame. Additionally, it is possible to introduce a quantization value (“Q”) into the comparison. A quantization value affects the likelihood of a macroblock in a current video frame 108 being recognized as a stationary macroblock or a non-stationary macroblock.

For example, in order to identify non-stationary macroblocks, the present disclosure contemplates adopting the existing concept of detection of all-zero quantization coefficient blocks for defining stationary macroblocks. This process begins by checking whether, for example, the coefficients in an 8×8 sub-block of a 16×16 macroblock will become zero after the quantization process. For example, the following formula may be applied to the pixels making up a given 8×8 sub-block:

$$SAD ( sum of absolute difference for location at ( x , y ) ) = {\sum }_{i = 0}^{i = 7} {\sum }_{j = 0}^{j = 7} \vert f ( x , y ) - f ( x + i , y + j ) \vert$$

In one example, if SAD<8Q, then the 8×8 sub-block will be defined as a zero-block. As noted above, Q represents the quantization value. In effect, the higher the Q value, the more likely that an 8×8 sub-block will be defined as a zero-block. The lower the Q value, the less likely that an 8×8 sub-block will be defined as a zero-block. Thus, the Q value effects how many zero-blocks will be detected in a given video frame. The Q value may be automatically set based on, for example, bandwidth availability between the first and second processors 104, 106. For example, the more bandwidth that is available, the lower the set Q value. This is because a low Q-value results in the detection of more non-stationary macroblocks, which means that pixel data describing each of those non-stationary macroblocks must be transmitted between the processors. Consequently, the larger the Q value, the less pixel data that will be sent between the processors. In line with the preceding discussion on determining whether a sub-block is a zero block, in one example, a 16×16 macroblock will only be defined as a zero-block if all four of its 8×8 sub-blocks are determined to be sub-blocks after application of the SAD equation.

Continuing with step 200, after the location of the plurality of non-stationary pixels in the current video frame 108 is determined, the non-stationary pixel location information 110 is provided for use by the second processor 106. In one example, the non-stationary pixel location information 110 is provided in the form of a map. The map indicates the location of all of the stationary and non-stationary macroblocks in the current video frame 108. The map is comprised of data indicating whether each macroblock in the current video frame is stationary or non-stationary based on the determination made in accordance with the procedure discussed above. For example, a value of zero (e.g., a bit-value set to zero) in the portion of the map corresponding to the macroblock located in the upper left-hand corner of the current video frame 108 may indicate that the macroblock in the upper left-hand corner of the current video frame 108 is stationary. Conversely, a value (e.g., a bit-value set to one) of one in the portion of the map corresponding to the macroblock located in the upper left-hand corner of the current video frame 108 may indicate that the macroblock in the upper left-hand corner of the current video frame 108 is non-stationary.

At step 202, the first processor 104 provides pixel data describing substantially only non-stationary pixels 112 in the current video frame 108, for use by the second processor 106. The pixel data describing substantially only non-stationary pixels 112 may comprise, for example, one luma and two chrominance values for each non-stationary pixel in the frame (e.g., YCbCr values, YUV values, YPbPr values, Y¹UV, etc.). Additionally, the pixel data may include coordinate values for the substantially only non-stationary pixels 112 in the frame such as, for example, x, y, and z coordinate values. In a preferred embodiment, pixel data describing only non-stationary pixels is provided for use by the second processor 106. However, it is recognized that some pixel data describing stationary pixels could also be provided for use by the second processor 106. As used herein, the term “pixel data describing substantially only non-stationary pixels” depends on the video encoding application. For example, for a low bit rate transmission (e.g., for video conferencing), the described method contemplates that no more than 20% of the total pixel data describes stationary pixels. In a high bit rate transmission, in one example, the described method contemplates that no more than 8-15% of the total pixel data describes stationary pixels. By limiting the amount of pixel data that is sent between the first processor 104 and the second processor 106, memory throughput is improved, thereby alleviating the bottleneck problem affecting existing encoding systems.

At step 204, the second processor 106 calculates motion vector data 116 for the plurality of non-stationary pixels based on the non-stationary pixel location information 110 and the pixel data describing substantially only non-stationary pixels 112. Motion vector data 116 is calculated for each plurality of non-stationary pixels (e.g., each non-stationary macroblock of pixels). That is to say, a different motion vector is calculated for each non-stationary plurality of pixels. As noted above, each motion vector describes the displacement of a plurality of non-stationary pixels (e.g., a macroblock of pixels) between a reference video frame 114 and the current video frame 108. A reference video frame 114 contains pixel data describing both stationary and non-stationary pixels. By calculating motion vectors only for the non-stationary plurality of pixels (and not for stationary pixels), motion estimation computing time is reduced. This in turn helps reduce the backlog of data being transferred between the first processor 104 and the second processor 106 in order to reduce, or alleviate entirely, the bottleneck problem faced by existing encoding systems. Furthermore, because the motion estimation computation is performed on a different processor than the first processor 104, the first processor 104 is free to handle other types of processing unrelated to motion estimation.

At step 206, the first processor 104 encodes the current video frame 108 using the motion vector data 116 for the plurality of non-stationary pixels from the second processor 106. The encoded video frame 118 may then be provided to a video decoder 120 for producing a decoded video frame 122. The encoded video frame 118 may comprise, for example, an I-frame, a P-frame, and/or a B-frame in a group of pictures (GOP) encoding scheme, as known in the art. However, the present disclosure is not limited to any particular encoding scheme and contemplates using any available encoding scheme to produce the encoded video frame 118. For example, the present disclosure contemplates use with encoding schemes such as the moving picture expert group (MPEG) schemes (e.g., MPEG-1, MPEG-2, MPEG-4, etc.), DivX5, H.264, or any other suitable video encoding scheme. That is to say, the described method is contemplated to apply equally well to any video encoding technique that requires motion estimation.

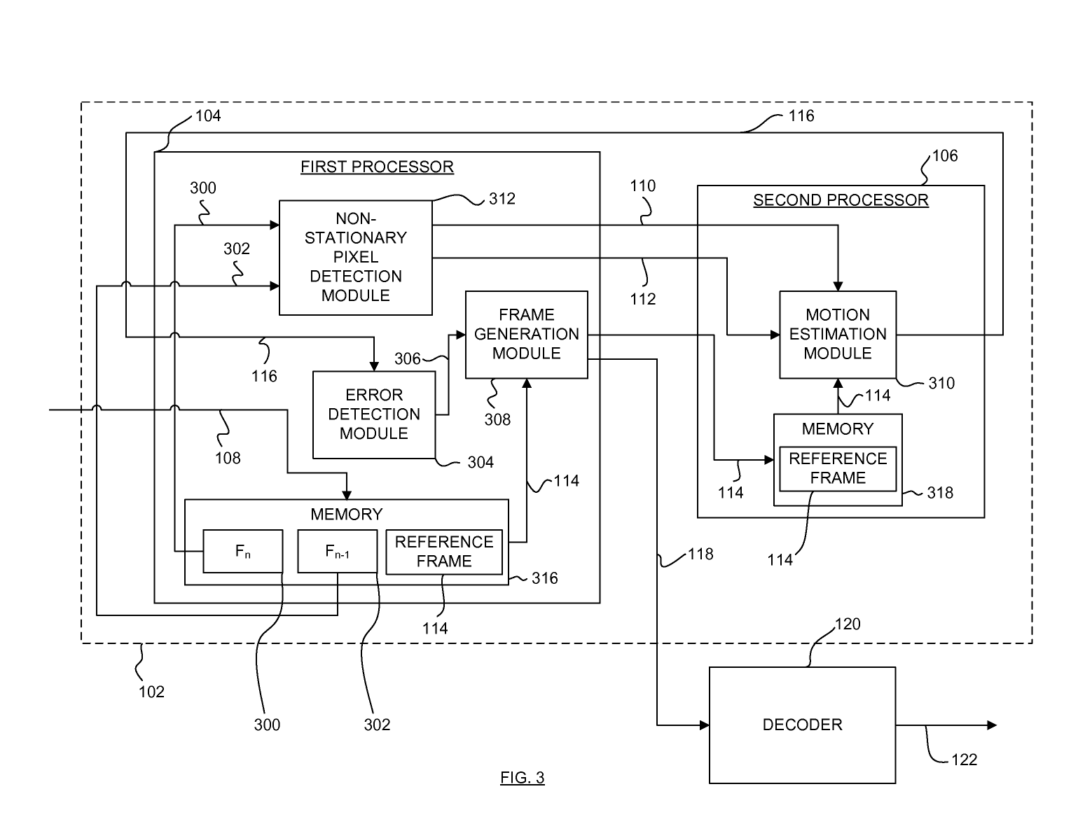

FIG. 3 is a block diagram generally depicting an encoder 102 for encoding video frames in accordance with one example set forth in the present disclosure. In particular, FIG. 3 depicts the sub-components of the first and second processors 104, 106 that are used to accomplish the functionality discussed, for example, with respect to FIG. 2. For example, the first processor 104 includes a non-stationary pixel detection module 312. As used herein, the term “module” can include an electronic circuit, one or more processors (e.g., shared, dedicated, or group of processors such as but not limited to microprocessors, digital signal processors, or central processing units) and memory that execute one or more software or firmware programs, combinational logic circuits, an application specific integrated circuit (ASIC), and/or other suitable components that provide the described functionality. In one example, the modules may comprise software and/or firmware stored in memory (e.g., memory 316, memory 318, or other suitable memory) being executed on one or both of the processors 104, 106.

The non-stationary pixel detection module 312 is operatively connected to memory 316 and a motion estimation module 310 located on the second processor 106. In a preferred embodiment, the first processor 104 has local memory 316 and the second processor 106 has local memory 318. However, it is contemplated that the first processor's memory 316 and the second processor's memory 318 could be the same memory. For example, the first and second processor may access shared memory (not shown) located either on the first processor 104, the second processor 106, or apart from both processors 104, 106 (e.g., in system memory apart from both processors 104, 106). However, providing local memory 316, 318 to both processors 104, 106 results in a reduction in encoding time by decreasing latency. Additionally, memory 316, 318 may be, for example, any combination of volatile/non-volatile memory components such as read-only memory (ROM), random access memory (RAM), electrically erasable programmable read-only memory (EE-PROM), or any other suitable digital storage medium.

The non-stationary pixel detection module 312 accepts pixel data describing pixels in the current video frame 300 (i.e., Fₙ) and pixel data describing pixels in the previous video frame 302 (i.e., Fₙ₋₁) as input from memory 316. The pixel data 300, 302 may include, for example, one luma and two chrominance values for each pixel in the frame (e.g., YCbCr values, YUV values, YPbPr values, Y¹UV, etc.). Additionally, the pixel data may include coordinate values for each pixel in the frame such as, for example, x, y, and z coordinate values indicating each pixel's location in the frame. The non-stationary pixel detection module 312 is operative to compare the pixel data in the current video frame 300 with corresponding pixel data in the previous video frame 302 to provide non-stationary pixel location information 110 (e.g., a map, as discussed above). After determining which pixels in the current video frame 108 are non-stationary pixels, the non-stationary pixel detection module 312 is operative to provide pixel data describing substantially only non-stationary pixels in the current video frame 112 for use by the second processor 106.

The non-stationary pixel detection module 312 is also operatively connected to a motion estimation module 310 in the second processor 106. The motion estimation module 310 accepts the non-stationary pixel location information 110 and the pixel data describing substantially only non-stationary pixels 112 as input from the non-stationary pixel detection module 312 in order to perform motion estimation. Specifically, the motion estimation module 310 is operative to determine a translational shift of the plurality of non-stationary pixels (e.g., the non-stationary macroblocks) between the reference video frame 114 and the current video frame 108 in order to calculate motion vector data 116. The motion estimation module 310

always has access to memory, such as the second processor's 106 local memory 318, storing a reference video frame 114. As such, the motion estimation module 310 calculates motion vector data 116 by determining the displacement of each plurality of non-stationary pixels (e.g., each macroblock of non-stationary pixels) between the reference video frame 114 and the current video frame 108, where the reference video frame 114 contains pixel data describing both stationary and non-stationary pixels. This may be accomplished, for example, by comparing the Y-values (i.e., luma values) of a plurality of non-stationary pixels in the current video frame 108 with the Y-values of the corresponding plurality of pixels in the reference video frame 114. After determining the motion vectors for each plurality of non-stationary pixels in the current video frame 108, the motion estimation module 310 provides the motion vector data 116 to an error detection module 308 in the first processor 104.

The error detection module 308, which is operatively connected to the motion estimation module 310, is operative to generate error detection data 306 in response to determining that the motion vector data 116 for the plurality of non-stationary pixels exceeds a predetermined value. Broadly speaking, the error detection module 304 identifies when a new reference frame 114 should be provided for use in calculating the motion vector data 116. The error detection module 304 makes this identification by analyzing the incoming motion vector data 116 and determining if the motion vector data 116 exceeds a predetermined value. For example, the predetermined value could be set to ten (recognizing that the specific value is a matter of design choice). In this example, if the motion vector data 116 indicates that a particular plurality of non-stationary pixels (e.g., a macroblock) have shifted ten or more pixels in-between the reference video frame 114 and the current video frame 108, then the error detection module 304 would generate error detection data 306 indicating that the predetermined value has been exceeded.

The error detection data 306 is provided to a frame generation module 308 operatively connected to the error detection module 304. The frame generation module 308 is operative to indicate that a new reference video frame 114 is available for use in calculating the motion vector data 116 in response to receiving error detection data 306. In one example, the frame generation module 308 indicates that a new reference video frame 114 is available for use in calculating the motion vector data 116 by reading out a new reference video frame 114 from memory 316 and providing the new reference video frame 114 to memory 318 in the second processor 106. In this example, the motion estimation module 310 then uses the new reference video frame 114 in calculating the motion vector data 116. In order to calculate meaningful (i.e., non-zero) motion vector data 116, the reference video frame 114 is ideally a video frame that was transmitted before the current video frame 108 in a given video stream (e.g., if the reference video frame 114 and the current video frame 108 are the same, there is no movement of pixels between the frames). However, it is contemplated that the motion estimation module 310 may receive the new reference video frame 114 via alternative means as well. For example, the motion estimation module 310 may alternatively request a new reference frame 114 from a shared memory (not shown) accessed by both processors 104, 106, or obtain the new reference video frame via other suitable memory access techniques known in the art.

The frame generation module 308 is also operative to provide an encoded video frame 118 to the video decoder 120 for producing a decoded video frame 122. The video decoder 120 may comprise, for example, any suitable decoder known in the art capable of decoding video frames that have been encoded in, for example, moving picture expert group (MPEG) schemes (e.g., MPEG-1, MPEG-2, MPEG-4, etc.), DivX5, H.264, or any other suitable video encoding scheme.

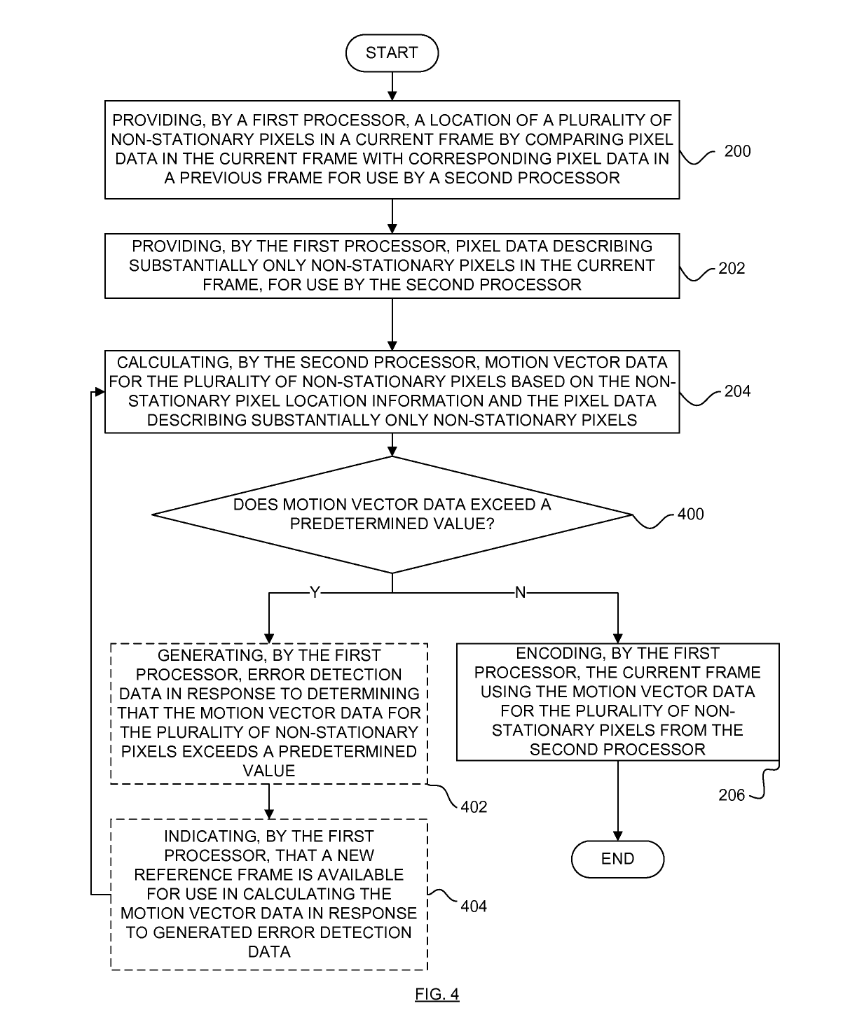

FIG. 4 is a flowchart illustrating another example of a method for encoding video frames using a plurality of processors. The method disclosed in FIG. 4 may be carried out by, for example, the encoder 102 depicted in FIG. 3. Accordingly, the method will be discussed with reference to the elements in the encoder 102. Steps 200-204 are carried out in accordance with the discussion of these steps provided with regard to FIG. 2. At step 400, a determination is made regarding whether the motion vector data exceeds a predetermined value. This step may be accomplished by, for example, the error detection module 304 in accordance with its above-described functionality. If the motion vector data does exceed a predetermined value, then the first processor 104 generates error detection data 306 in response to the determination that the motion vector data 116 for the plurality of non-stationary pixels exceeds a predetermined value. This step may also be accomplished by, for example, the error detection module 304 in accordance with its above-described functionality. At step 404, the first processor 104 indicates that a new reference video frame 114 is available for use in calculating the motion vector data 116 in response to generated error detection data 306. This step may be accomplished by, for example, the frame generation module 308 in accordance with its above-described functionality. If however, at step 400, it is determined that the motion vector data 116 does not exceed the predetermined value, then the method continues to step 206, which is carried out in accordance with the discussion of that step as provided with regard to FIG. 2.

Among other advantages, the disclosed methods and system provide for accelerated video encoding, including motion estimation. The acceleration is accomplished by partitioning the encoding processing between a plurality of processors and reducing the amount of pixel data being sent between the processors. To that end, the disclosed methods and system also improve upon the latency created by transferring encoding processing operations between processors. Other advantages will be recognized by those of ordinary skill in the art.

Also, integrated circuit design systems (e.g., workstations) are known that create integrated circuits based on executable instructions stored on a computer readable memory such as but not limited to CD-ROM, RAM, other forms of ROM, hard drives, distributed memory, etc. The instructions may be represented by any suitable language such as but not limited to hardware descriptor language or other suitable language. As such, the video encoder described herein may also be produced as integrated circuits by such systems. For example, an integrated circuit may be created using instructions stored on a computer readable medium that when executed cause the integrated circuit design system to create an integrated circuit that is operative to provide, by a first processor, a location of a plurality of non-stationary pixels in a current frame by comparing pixel data in the current frame with corresponding pixel data in a previous frame for use by a second processor; provide, by the first processor, pixel data describing substantially only non-stationary pixels in the current frame, for use by the second processor; calculate, by the second processor, motion vector data for the plurality of non-stationary pixels based on the non-stationary pixel location information and the pixel data describing substantially only non-stationary pixels; and encode, by the first processor, the current frame using the motion vector data for the plurality of non-stationary pixels from the second processor. Integrated circuits having the logic that performs other of the operations described herein may also be suitably produced.

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. A method for encoding video frames using a plurality of processors, comprising:
providing, by a first processor, a location of a plurality of non-stationary pixels in a current frame by comparing pixel data in the current frame with corresponding pixel data in a previous frame for use by a second processor;
providing, by the first processor, pixel data describing substantially only non-stationary pixels in the current frame, for use by the second processor;
calculating, by the second processor, motion vector data for the plurality of non-stationary pixels based on the non-stationary pixel location information and the pixel data describing substantially only non-stationary pixels; and
encoding, by the first processor, the current frame using the motion vector data for the plurality of non-stationary pixels from the second processor.

2. The method of claim 1, further comprising:
generating, by the first processor, error detection data in response to determining that the motion vector data for the plurality of non-stationary pixels exceeds a predetermined value.

3. The method of claim 2, further comprising:
indicating, by the first processor, that a new reference frame is available for use in calculating the motion vector data in response to generated error detection data.

4. The method of claim 1, wherein calculating motion vector data comprises determining a translational shift of the plurality of non-stationary pixels between a reference frame and the current frame.

5. The method of claim 4, wherein the reference frame comprises both pixel data describing non-stationary pixels in the current frame and pixel data describing stationary pixels in the current frame.

6. The method of claim 5, wherein the previous frame comprises the reference frame.

7. The method of claim 1, wherein the pixel data describing substantially only non-stationary pixels in the current frame comprises pixel data describing only non-stationary pixels in the current frame.

8. A video encoder for encoding video frames, comprising:
a first processor operative to:
provide a location of a plurality of non-stationary pixels in a current frame by comparing pixel data in the current frame with corresponding pixel data in a previous frame for use by a second processor; and
provide pixel data describing substantially only non-stationary pixels in the current frame, for use by the second processor;
the second processor operatively connected to the first processor, the second processor operative to calculate motion vector data for the plurality of non-stationary pixels based on the non-stationary pixel location information and the pixel data describing substantially only non-stationary pixels; and
wherein the first processor is further operative to encode the current frame using the motion vector data for the plurality of non-stationary pixels from the second processor.

9. The video encoder of claim 8, wherein the first processor comprises:
an error detection module operative to generate error detection data in response to determining that the motion vector data for the plurality of non-stationary pixels exceeds a predetermined value.

10. The video encoder of claim 9, wherein the first processor comprises:
a frame generation module operative to indicate that a new reference frame is available for use in calculating the motion vector data in response to receiving error detection data.

11. The video encoder of claim 8, wherein the second processor comprises:
a motion estimation module operative to determine a translational shift of the plurality of non-stationary pixels between a reference frame and the current frame in order to calculate motion vector data.

12. The video encoder of claim 11, wherein the reference frame comprises both pixel data describing non-stationary pixels in the current frame and pixel data describing stationary pixels in the current frame.

13. The video encoder of claim 12, wherein the previous frame comprises the reference frame.

14. The video encoder of claim 8, wherein the first processor comprises:
a non-stationary pixel detection module operative to determine the location of the plurality of non-stationary pixels in the current frame and provide both non-stationary pixel location information corresponding to the current frame for use by the second processor and pixel data describing substantially only non-stationary pixels in the current frame for use by the second processor.

15. A system for encoding and decoding video frames using a plurality of processors, comprising:
a first processor operative to:
provide a location of a plurality of non-stationary pixels in a current frame by comparing pixel data in the current frame with corresponding pixel data in a previous frame for use by a second processor; and
provide pixel data describing substantially only non-stationary pixels in the current frame, for use by the second processor;
the second processor operatively connected to the first processor, the second processor operative to calculate motion vector data for the plurality of non-stationary pixels based on the non-stationary pixel location information and the pixel data describing substantially only non-stationary pixels;
wherein the first processor is further operative to encode the current frame using the motion vector data for the plurality of non-stationary pixels from the second processor; and
a decoder operatively connected to the first processor, the decoder operative to decode the encoded current frame to provide a decoded current frame.

16. The system of claim 15, wherein the first processor comprises:
an error detection module operative to generate error detection data in response to determining that the motion vector data for the plurality of non-stationary pixels exceeds a predetermined value.

17. The system of claim 16, wherein the first processor comprises:
a frame generation module operative to indicate that a new reference frame is available for use in calculating the motion vector data in response to receiving error detection data.

18. The system of claim 15, wherein the second processor comprises:
a motion estimation module operative to determine a translational shift of the plurality of non-stationary pixels between a reference frame and the current frame in order to calculate motion vector data.

19. The system of claim 18, wherein the reference frame comprises both pixel data describing non-stationary pixels in the current frame and pixel data describing stationary pixels in the current frame.

20. The system of claim 19, wherein the previous frame comprises the reference frame.

21. A processor for encoding video frames using a plurality of processors, the processor operative to:
provide a location of a plurality of non-stationary pixels in a current frame by comparing pixel data in the current frame with corresponding pixel data in a previous frame for use by a second processor;
provide pixel data describing substantially only non-stationary pixels in the current frame, for use by the second processor; and
encode the current frame using motion vector data calculated by the second processor for the plurality of non-stationary pixels based on the non-stationary pixel location information and the pixel data describing substantially only non-stationary pixels.
